(19) United States
(12) Patent Application Publication
(10) Pub. No.: US 2005/0029963 A1
(43) Pub. Date: Feb. 10, 2005

(54) Power supply apparatus and method of controlling the same

(75) Inventor: Seung-jae Lee, Yongin city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/836,351

(22) Filed: May 3, 2004

(30) Foreign Application Priority Data
Aug. 8, 2003 (KR) 2003-54884

(51) Int. Cl. H05B 37/02

(52) U.S. Cl. 315/291; 315/224

(57) ABSTRACT

A power supply apparatus with a safety disconnect and a method of operating the power supply apparatus. A grounding sensor detects whether a frame ground of the power supply is connected to an external grounding point and shuts down output power if the frame ground terminal is not connected to the external grounding point. A neutral rectifier rectifies an output voltage of a voltage stabilizer and a voltage comparator outputs a non-grounding signal of a predetermined level if an output voltage of the neutral rectifier is lower than a predetermined criterion voltage. A switching part shuts down output power in response to the non-grounding signal.

### CROSS-REFERENCE TO RELATED APPLICATIONS

This application claims the benefit of Korean Patent Application No. 2003-54884, filed Aug. 8, 2003, in the Korean Intellectual Property Office, the disclosure of which is incorporated herein by reference.

### BACKGROUND OF THE INVENTION

1. Field of the Invention

The present invention relates to a power supply apparatus and a method of controlling the same, and more particularly, to a power supply apparatus and a method of controlling the same which reduces a hazard by safely shutting down the power supply when a frame ground terminal is not grounded.

2. Description of the Related Art

Generally, an electronic appliance requires a direct current (DC) power supply which converts commercial alternating current (AC) into direct current for an operation. A switching mode power supply (SMPS) is widely used as the DC power supply because of high efficiency and light weight.

Electronic appliances operating with the power supplied from the DC power supply such as a laundry machine, a refrigerator, and a microwave are usually covered with conductive material on their surface. Accordingly, a frame ground terminal is used to dissipate an electric leakage occurring within the electronic appliance by connecting a ground wire from the frame ground terminal to a grounding point such as an earth ground or a grounding terminal in a building.

However, connecting the ground wire to the grounding point may not be convenient because an installation position of the electronic appliance is distant from the grounding point. Also, an electronic appliance using a three-phase wall outlet cannot be used in a building not installed with the grounding terminal because the ground wire from the frame ground terminal cannot be connected to the grounding point. Accordingly, there exists a safety hazard due to occurrence of the electrical leakage.

### SUMMARY OF THE INVENTION

Accordingly, an aspect of the present invention is to provide a power supply apparatus and a method of controlling the same which reduces a hazard by safely shutting down the power supply when a frame ground terminal is not grounded.

Additional aspects and advantages of the invention will be set forth in part in the description which follows and, in part, will be obvious from the description, or may be learned by practice of the invention.

The foregoing and/or other aspects of the present invention are achieved by providing a power supply apparatus which converts commercial AC power input through a pair of power input terminals into predetermined DC power and outputs the DC power through power output terminals. The power supply comprises a switching part installed on a power supply line between the power input terminals and the power output terminals and which turns on/off the power supplied to the power output terminals; a grounding sensor which detects whether a frame ground terminal in the power supply apparatus is connected to an external grounding point; and a controller which turns off the switching part to shut down the power supplied from the power input terminals to the power output terminals if the grounding sensor detects that the frame ground terminal is not connected to the grounding point.

According to an aspect of the invention, the power supply apparatus may further comprise a power stabilizer installed between the power input terminals and the frame ground terminals, and which stabilizes the power by removing noise of the commercial AC power input through the power input terminals, wherein the grounding sensor comprises: a neutral rectifier which rectifies an output voltage of the voltage stabilizer on a side of a neutral input terminal; and a voltage comparator which outputs a non-grounding signal of a predetermined level if an output voltage of the neutral rectifier is lower than a predetermined voltage.

According to an aspect of the invention, the predetermined criterion voltage may be equal to a voltage of the frame ground terminal.

According to an aspect of the invention, the controller comprises a switch which turns off according to the non-grounding signal of the voltage comparator, wherein the switching part comprises a relay which shuts down power supplied from the power input terminals to the power output terminals when the switch turns off.

According to an aspect of the invention, the power supply apparatus further comprises: a capacitance installed between the neutral rectifier and the voltage comparator to remove noise of the output voltage of the neutral rectifier; and a plurality of dividing resistors which divide an output voltage of the capacitor according to a predetermined ratio and output the divided output voltage to the input terminals of the voltage comparator.

According to another aspect of the present invention, the above and/or other aspects of the invention may be achieved by providing a method of controlling a power supply apparatus which converts commercial AC power input through a pair of power input terminals into predetermined DC power and outputs the DC power through power output terminals. The method comprises: detecting whether a frame ground terminal of the power supply apparatus is connected to an external grounding point; and switching to shut down power supplied from the power input terminals to the power output terminals if the frame ground terminal is detected not to, be connected to the external grounding point.

According to an aspect of the invention, the method of controlling the power supply apparatus further comprises stabilizing the power by removing noise of the commercial AC power input through a neutral input terminal among the power input terminals, wherein the of detecting whether the frame ground terminal is grounded or not comprises: rectifying the stabilized output voltage on a side of the neutral input terminal; and outputting a non-grounding signal of a predetermined level if the rectified voltage is lower than a predetermined criterion voltage.

According to an aspect of the invention, the predetermined criterion voltage may be equal to a voltage of the frame ground terminal.

According to an aspect of the invention, the method of controlling the power supply apparatus may further comprise switching to shut down the power supplied from the power input terminals to the power output terminals according to the non-grounding signal.

According to an aspect of the invention, the method of controlling the power supply apparatus may further comprise: removing the noise of the rectified output voltage on a side of the neutral input terminal; dividing the voltage stripped of the noise according to a predetermined ratio; and comparing the divided voltage with a predetermined criterion voltage.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a block diagram of a power supply apparatus according to an embodiment of the present invention;

FIG. 2 a partial circuit diagram of an embodiment of the apparatus shown in FIG. 1;

FIG. 3 is a control flow chart of the power supply apparatus according to present invention;

FIG. 4 is a more detailed control flow chart of the power supply apparatus according to the present invention; and

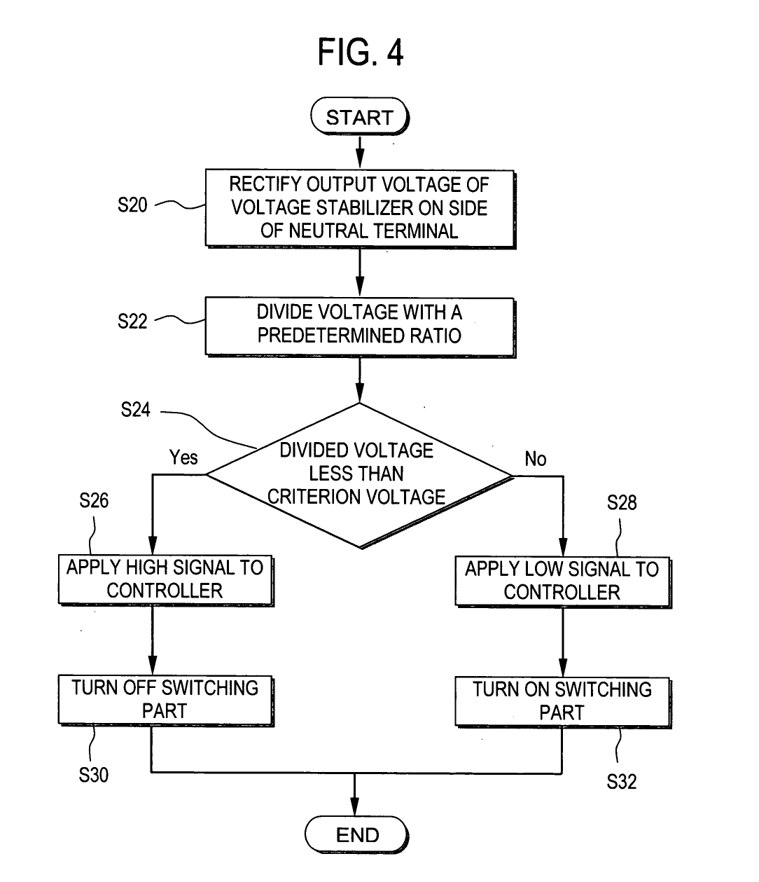

FIG. 5 is a partial circuit diagram of another embodiment of the apparatus shown in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

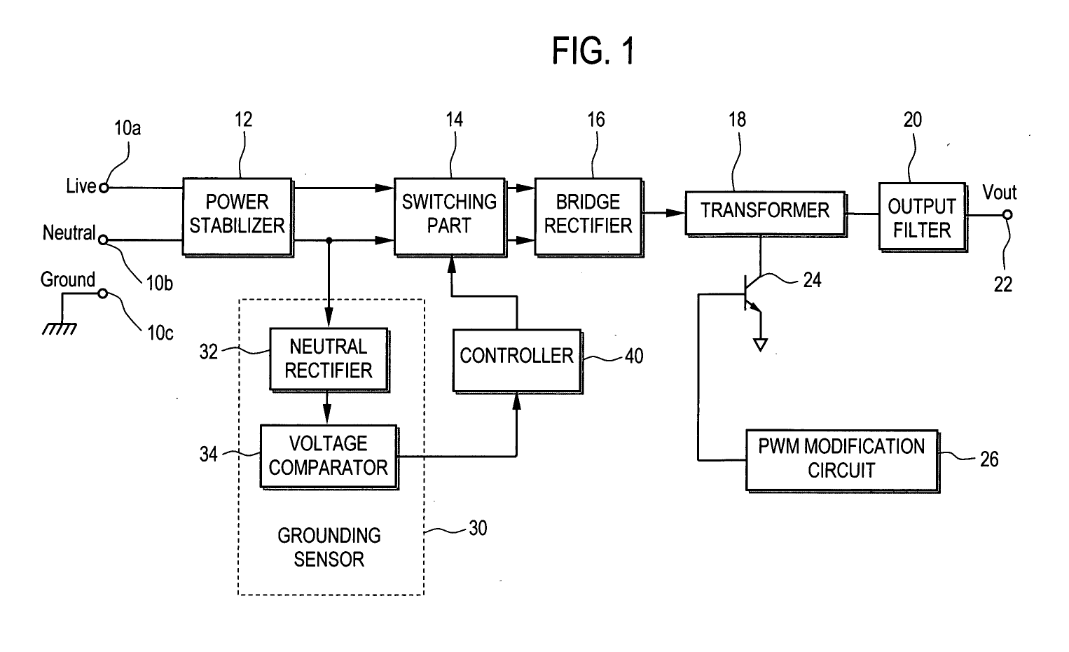

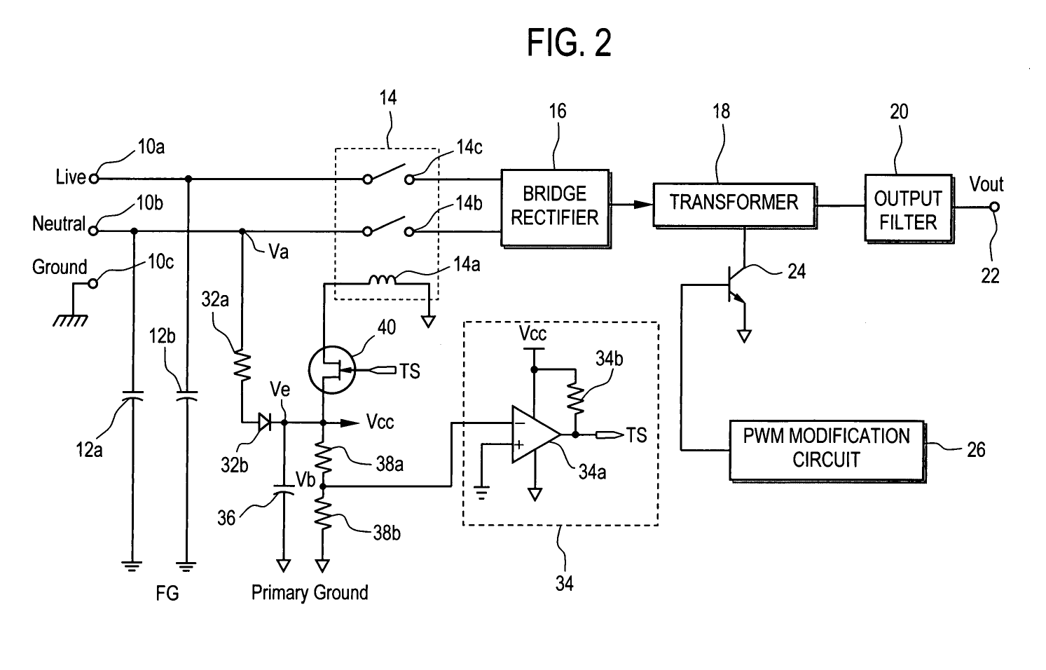

FIG. 1 is a block diagram of a power supply apparatus according to an embodiment of the present invention, and FIG. 2 is a partial circuit of the block diagram in FIG. 1. As illustrated in FIGS. 1 and 2, the power supply apparatus comprises a power stabilizer 12 which removes noise from commercial alternating current (AC) power supplied to the power supply; a bridge rectifier 16 which rectifies an output voltage of the power stabilizer 12; a transformer 18, a transistor 24 and a PWM modification circuit 26 which convert the output voltage of the bridge rectifier 16 into a DC voltage having a predetermined level; an output filter 20 which filters the DC voltage output from the transformer 18; a switching part 14 installed between the power stabilizer 12 and the bridge rectifier 16; a grounding sensor 30 which detects whether a frame ground FG terminal of the electronic appliance is connected to a grounding point (not shown); and a controller 40 which controls the switching part 14 according to a result of detection by the grounding sensor 30.

The power supply is conventionally provided with a live terminal 10a which receives the commercial AC power, a neutral terminal 10b, and a ground terminal 10c. Herein, the live terminal 10a is supplied with a positive current while the neutral terminal 10b is supplied with a negative current.

The power stabilizer 12 may be realized by capacitances 12a and 12b where one end of the a capacitance 12b is connected to the live terminal 10a, one end of the capacitance 12a is connected to the neutral terminal 10b while the other ends of the capacitances 12a and 12b are connected to the frame ground terminal FG. Herein, the power stabilizer 12 prevents the noise of the commercial AC power coming through the live terminal 10a and the neutral terminal 10b from flowing into the power supply and prevents noise generated in the power supply from flowing into the power input lines.

The bridge rectifier 16 full-wave rectifies the output power of the power stabilizer 12 using a diode bridge, and applies a DC voltage filtered by a smoothing capacitance (not shown) to a primary coil of the transformer 18.

The pulse width modulation (PWM) modification circuit 26 provides a PWM waveform to the transistor 24 to control a switching operation of the transistor 24. If the transistor 24 operates switching, an AC voltage is induced from the primary coil of the transformer 18 to a secondary coil of the transformer 18. Accordingly, ripple and the noise of the AC voltage induced into the secondary coil of the transformer 18 are removed through the output filter 20 so that the AC voltage is converted into DC voltage according to a ratio of a number of turns of the primary coil and a number of turns of the secondary coil of the transformer 18 and supplied to power consuming electronic components.

The grounding sensor 30 comprises a neutral rectifier 32 which half-wave rectifies an output voltage Va of the power stabilizer 12 on a side of the neutral terminal 10b using a resistor 32a and a diode 32b, and a voltage comparator 34 which compares the output voltage of the neutral rectifier 32 with a predetermined criterion voltage to output a result signal of the comparison.

Herein, noise of an output voltage Ve of the neutral rectifier 32 is removed with a capacitance 36, and the output voltage Ve is divided with a predetermined ratio by dividing resistors 38a and 38b and outputs a divided voltage Vb to an inverting input terminal (−) of the voltage comparator 34.

The voltage comparator 34 outputs the comparison result signal TS by comparing the divided voltage Vb with the predetermined criterion voltage. The criterion voltage is set to be equal to the voltage of the frame ground terminal FG in this embodiment of the present invention. Herein the resistor 34b is a pull-up resistor.

In a case that the frame ground terminal FG is connected to the grounding point, such as, for example, along at least one of the paths 11a and 11b or the path 11c shown in FIG. 2, the voltage of the frame ground terminal FG has OV and the voltage Va of the input line on the side of the neutral terminal 10b has a voltage higher than the voltage of the frame ground terminal FG.

If the voltage Va of the input line on the side of the neutral terminal 10b is applied to the inverting input terminal of the voltage comparator 34 through the neutral rectifier 32, the capacitance 36, and the dividing resistors 38a and 38b, the voltage comparator 34 outputs a low signal because the voltage Va is higher than the criterion voltage of a non-inverting input terminal, or OV.

Meanwhile, if the frame ground terminal FG is not connected to the grounding point, the voltage of the frame ground terminal becomes higher, and the voltage Va of the input line on the side of the negative terminal 10b becomes lower than the voltage of the frame ground terminal FG or takes negative voltage.

If the voltage Va of the input line on the side of the negative terminal 10b is applied to the inverting input terminal of the voltage comparator 34 through the neutral rectifier 32, the capacitor 36, and dividing resistors 38a and 38b, the voltage comparator 34 outputs a high signal because the voltage Va is lower than the criterion voltage of the non-inverting input terminal, or the voltage of the frame ground terminal FG.

The switching part 14 may be provided on power lines between the live terminal 10a and the neutral terminal 10b and the bridge rectifier 16 to have contact points 14b and 14c shutting or opening the power according to whether a current flows in the coil 14a.

The controller 40 may be a field effect transistor 40 turning on/off according to the output signal of the voltage comparator 34. The field effect transistor 40 turns off when a high signal from the voltage comparator 34 is applied on a gate terminal, and turns on when a low signal from the voltage comparator 34 is applied on the gate terminal.

If the field effect transistor 40 turns on, the coil 14a of a relay forming the switching part 14 is supplied with current. Accordingly, contact points 14b and 14c of the relay 14 close, providing the output voltage of the power stabilizer 12 to the bridge rectifier 16.

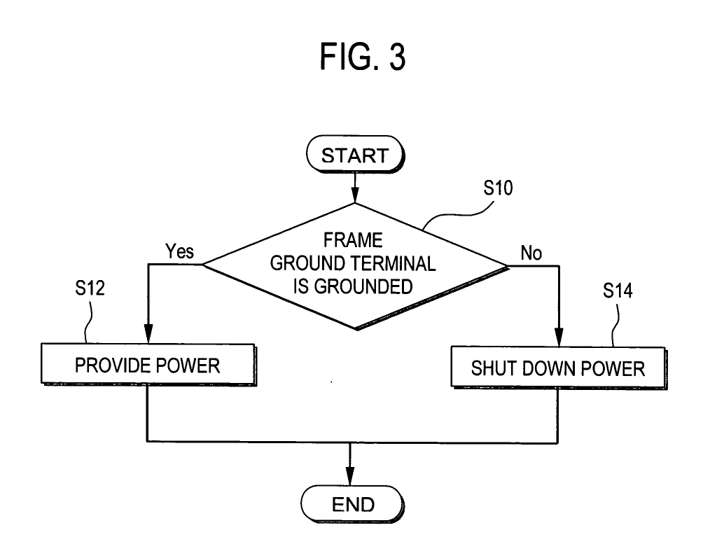

FIG. 3 illustrates a control flow chart of the power supply apparatus according to the embodiment of the present invention. The grounding sensor 30 detects whether the frame ground terminal FG is grounded, i.e., connected to the grounding point. If the frame ground terminal FG is detected to be grounded, the controller 40 turns on the switching part 14 to supply the power from power input terminals, or the live terminal 10a and the neutral terminal 10b to power output terminal 22 as operation S12. Meanwhile, if the frame ground is detected not to be grounded, the controller 40 turns off the switching part 14 to shut down the power supplied from the power input terminals, or the live terminal 10a and the neutral terminal 10b to power output terminal 22 at operation S14. Accordingly, the embodiment of the present invention prevents a hazard due to the electrical leakage by shutting down the power in safety when the frame ground terminal FG is not grounded.

Herein below, the control of the power supply apparatus according to the embodiment of the present invention will be described.

The neutral rectifier 32 rectifies the output voltage Va of the power stabilizer 12 on the side of the neutral terminal 10b at operation S20. The noise of the rectified voltage Ve is removed by the a capacitance 36, and the voltage Ve is divided with a predetermined ratio by the dividing resistors 38a and 38b to be applied to the voltage comparator 34 at operation S22. The voltage comparator 34 compares the divided voltage Vb with the criterion voltage that is equal to the voltage of the frame ground terminal FG at operation S24. After a comparison, the high signal is applied to the controller 40 if the divided voltage Vb is lower than the criterion voltage at operation S26. Accordingly, the controller 40 shuts down the power by turning off the switching part 14 at operation S30. Meanwhile, the voltage comparator 34 applies the low signal to the controller 40 if the divided voltage Vb is greater than the criterion voltage at operation S28. Accordingly, the controller 40 supplies the power by turning on the switching part 14 at operation S32.

In the embodiment described above, the controller 40 is the field effect transistor 40 turning on/off according to the output signal of the voltage comparator 34. However, the controller may be a microcomputer programmed to control the switching part 14 according to the output signal of the voltage comparator 34.

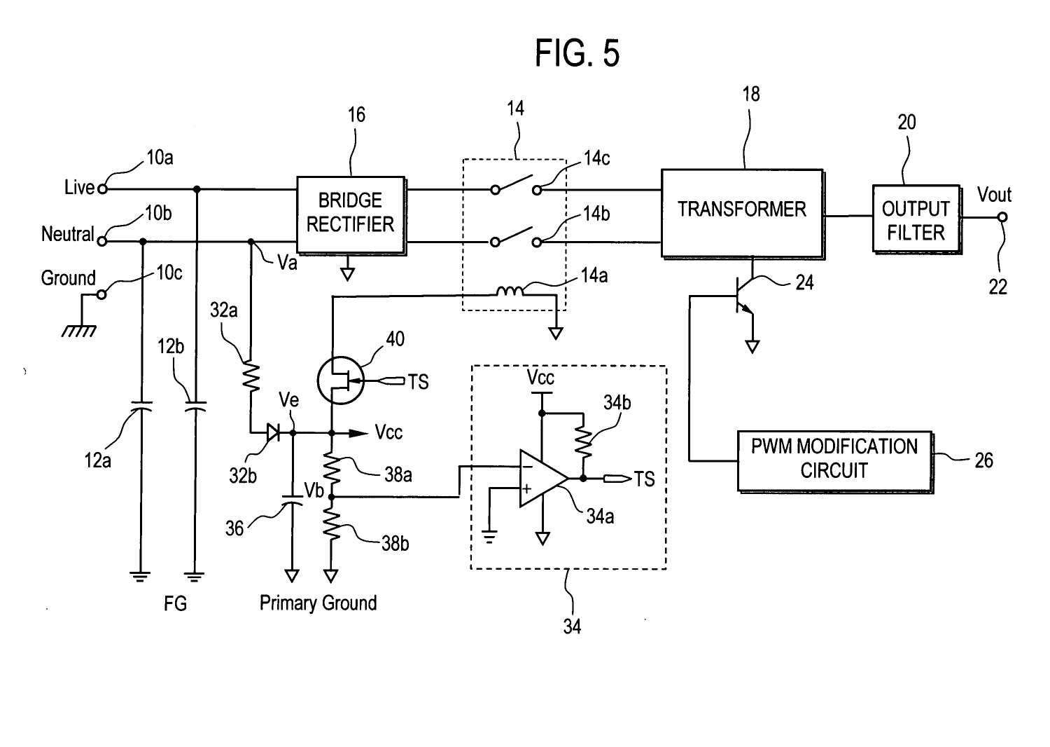

In the embodiment described above with respect to FIG. 2, the switching part 14 is provided before the bridge rectifier 16, however, the switching part 14 may be alternatively provided such as, for example, a power line between the bridge rectifier 16 and the transformer 18, or a power line between the transformer 18 and the output filter 20, or a power line between the output filter 20 and the power output terminals 22. An example of another embodiment is shown in FIG. 5.

The voltage comparator 34 may be configured to be provided with the criterion voltage on the inverting input terminal while the non-inverting input terminal are configured to be applied with the voltage Vb divided by the dividing resistors 38a and 38b. Herein, the field effect transistor 40 may be configured to turn on when the high signal is applied on the gate terminal.

As illustrated, the embodiment according to the present invention reduces the safety hazard due to the electrical leakage by detecting whether the frame ground terminal FG of the power supply apparatus is grounded and shutting down the power supply when the frame ground terminal FG is detected not to be grounded.

As illustrated above, the embodiment according to the present invention provides the power supply apparatus and a method of controlling the power supply apparatus to reduce the hazard by safely shutting down the power supply when the frame ground terminal is not grounded.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A power supply apparatus for converting commercial alternating current (AC) power input through a pair of power input terminals into a predetermined direct current (DC) power and outputting the DC power through power output terminals, comprising:
a switching part installed on a power supply line between the power input terminals and the power output terminals and which turns on/off the power supplied to the power output terminals;
a grounding sensor which detects whether a frame ground terminal in the power supply apparatus is connected to an external grounding point; and
a controller which turns off the switching part to shut down the power supplied to the power output terminals if the grounding sensor detects that the frame ground terminal is not connected to the external grounding point.

2. The power supply apparatus according to claim 1, wherein:
the power supply apparatus further comprises a power stabilizer installed between the power input terminals and the frame ground terminals, and which stabilizes the input power by removing noise of the commercial AC power, and
the grounding sensor comprises:
a neutral rectifier which rectifies an output voltage of the voltage stabilizer on a side of a neutral input terminal; and
a voltage comparator which outputs a non-grounding signal of a predetermined level if an output voltage of the neutral rectifier is lower than a predetermined criterion voltage.

3. The power supply apparatus according to claim 2, wherein the criterion voltage is equal to a voltage of the frame ground terminal.

4. The power supply apparatus according to claim 2, wherein:
the controller comprises a switch which turns off according to the non-grounding signal of the voltage comparator; and
the switching part comprises a relay which shuts down power supplied from the power input terminals to the power output terminals when the switch turns off.

5. The power supply apparatus according to claim 4, further comprising:
a capacitance installed between the neutral rectifier and the voltage comparator to remove noise of the output voltage of the neutral rectifier; and
a plurality of dividing resistors which divides an output voltage of the capacitance with a predetermined ratio and outputs the divided output voltage to the input terminals of the voltage comparator.

6. A method of controlling a power supply apparatus for converting commercial alternating current (AC) power input through a pair of power input terminals into a predetermined direct current (DC) power and outputting the DC power through power output terminals, comprising:
detecting whether a frame ground terminal of the power supply apparatus is connected to an external grounding point; and
switching to shut down power supplied from the power input terminals to the power output terminals if the frame ground terminal is detected not to be connected to the grounding point.

7. The method of controlling the power supply apparatus according to claim 6, further comprising stabilizing the power by removing noise of the commercial AC power inputted through a neutral input terminal among the power input terminals, wherein the detecting of whether the frame ground terminal is grounded comprises:
rectifying the stabilized output voltage on a side of the neutral input terminal; and
outputting a non-grounding signal of a predetermined level if the rectified voltage is lower than a predetermined criterion voltage.

8. The method of controlling the power supply apparatus according to claim 7, wherein the criterion voltage is equal to voltage of the frame ground terminal.

9. The method of controlling the power supply apparatus according to claim 7, further comprising:
switching to shut down the power supplied from the power input terminals to the power output terminals according to the non-grounding signal.

10. The method of controlling the power supply apparatus according to claim 9, further comprising:
removing the noise of the rectified output voltage on a side of the neutral input terminal;
dividing the voltage removed of the noise with a predetermined ratio; and
comparing the divided voltage with a predetermined criterion voltage.

11. A power supply apparatus for converting commercial AC power and outputting DC power, the apparatus comprising:
a bridge rectifier which converts the commercial AC power to an intermediate DC power having a predetermined voltage relative to a primary ground determined by the bridge rectifier;
a pulse width modulation circuit which converts the intermediate DC power to output DC power;
a controllable switch which controls a supply of the intermediate DC power to the pulse width modulation circuit in response to a control signal;
a grounding sensor which detects whether a frame ground of the power supply apparatus is connected to an external grounding point by comparing a sample voltage and a potential of the frame ground, wherein the sample voltage is determinable by a difference between a rectified voltage obtained from a first input of the commercial AC power and a voltage of the primary ground of the bridge rectifier; and
a controller which generates the control signal based on the comparison.

12. The power supply apparatus of claim 11, wherein the rectified voltage is obtained from a neutral voltage of the commercial AC power.

13. The power supply apparatus of claim 11, further comprising:
a first capacitance connected between the first input of the commercial AC power and the frame ground; and
a second capacitance connected between a second input of the commercial AC power and the frame ground, wherein:
where the frame ground is connected to the external grounding point, the first and second capacitances act as filters of the input power by conducting noise of the input AC power to the frame ground; and
where the frame ground is not connected to the external grounding point, the voltage of the frame ground being compared with the sample voltage changes due to a current flow in the capacitances so that the control signal is not generated based on the comparison.
